(19) United States
(12) Patent Application Publication
(10) Pub. No.: US 2022/0338665 A1
(43) Pub. Date: Oct. 27, 2022

(54) BEVERAGE MACHINE

(71) Applicant: Keurig Green Mountain, Inc., Burlington, MA (US)

(72) Inventors: Geoffrey Y. Smith, Melrose, MA (US); Kim Lai Wong, Senai, Johor (MY); Wen Yin Lee, Senai, Johor (MY); Kit Hong Lee, Senai, Johor (MY)

(73) Assignee: Keurig Green Mountain, Inc., Burlington, MA (US)

(21) Appl. No.: 17/640,248

(22) PCT Filed: Sep. 17, 2020
(86) PCT No.: PCT/US2020/051204

§ 371 Date: Mar. 3, 2022

Related U.S. Application Data
(60) Provisional application No. 62/903,349, filed on Sep. 20, 2019.

(51) Int. Cl. A47J 31/36; A47J 31/40

(52) U.S. Cl. CPC A47J 31/3623; A47J 31/405

(57) ABSTRACT

A beverage machine may have a first brew chamber for forming larger, multi-serving beverages, and a second brew chamber for receiving beverage cartridges to form single-serve beverages. Aspects relating to relative positioning of the brew chambers and associated components are described herein. The beverage machine may include a user interface that displays different selection options based on which of the two brew chambers is being used to form a beverage. The beverage machine may include a handle that may be manipulated by a user to both open a brew chamber and to remove a brew basket from the brew chamber. The beverage machine may include a liquid reservoir that removably couples to the machine housing at different discrete positions. The beverage machine may include a liquid supply lid that may be removably coupled to the housing.

### CROSS REFERENCE TO RELATED APPLICATION

This application claims the benefit of U.S. Provisional Application No. 62/903,349, filed Sep. 20, 2019, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Pat. No. 8,361,527 discloses a beverage forming system that uses a beverage cartridge containing a beverage material to make a beverage by introducing liquid into the cartridge. Liquid provided to the cartridge may be heated in a tank prior to delivery to the cartridge.

### SUMMARY

In some embodiments, a beverage machine includes a housing, a user interface, a liquid supply, a first chamber, and a second chamber. The user interface is oriented to be viewed by a user positioned at a front of the beverage machine. The liquid supply is configured to provide a liquid for forming a beverage and is coupled to the housing. The first chamber is configured to hold a first beverage material for mixing with liquid from the liquid supply to form a first beverage. The second chamber includes a cartridge holder, which is configured to receive a beverage cartridge that has a second beverage material for mixing with liquid from the liquid supply to form a second beverage. The second chamber is distinct from the first chamber and is disposed behind the first chamber.

In some embodiments, a beverage machine includes a housing, a liquid supply, a first chamber, a second chamber, a base, and a user interface. The liquid supply is configured to provide a liquid for forming a beverage and is coupled to the housing. The first chamber is configured to hold a first beverage material for mixing with liquid from the liquid supply to form a first beverage. The second chamber includes a cartridge holder, which is configured to receive a beverage cartridge that has a second beverage material for mixing with liquid from the liquid supply to form a second beverage. The base supports the beverage machine and is at a bottom of the beverage machine. The user interface is oriented to be viewed by a user positioned at a front of the beverage machine. The user interface is disposed above the first chamber.

In some embodiments, a beverage machine includes a housing, a liquid supply, a first chamber, a second chamber, a base, and a flow path. The liquid supply is configured to provide a liquid for forming a beverage and is coupled to the housing. The first chamber is configured to hold a first beverage material for mixing with liquid from the liquid supply to form a first beverage. The second chamber includes a cartridge holder, which is configured to receive a beverage cartridge that has a second beverage material for mixing with liquid from the liquid supply to form a second beverage. The flow path fluidly connects the second chamber to the first chamber.

In some embodiments, a beverage machine includes a liquid supply, a first chamber, a second chamber, and a user interface. The liquid supply is configured to provide a liquid for forming a beverage. The first chamber is configured to hold a first beverage material for mixing with liquid from the liquid supply to form a first beverage. The second chamber includes a cartridge holder, which is configured to receive a beverage cartridge that has a second beverage material for mixing with liquid from the liquid supply to form a second beverage. The user interface is configured to permit selection of either a first mode for forming the first beverage in the first chamber or a second mode for forming the second beverage in the second chamber. The user interface is configured to provide volume selection options based on the selected mode. Selection of the first mode causes the user interface to provide a first set of volume selection options. Selection of the second mode causes the user interface to provide a second set of volume selection options that are different from the first set of volume selection options.

In some embodiments, a beverage machine includes a housing, a liquid supply, a basket, a handle attached to the basket, and a chamber. The liquid supply is configured to provide a liquid for forming a beverage. The basket is configured to receive a beverage ingredient for mixing with liquid from the liquid supply to form a beverage. The chamber is configured to hold the basket and to receive liquid from the liquid supply. The chamber is movable relative to the housing between an open position and a closed position. When the chamber is in the closed position, at least a portion of the handle is positioned outside of the chamber. At least a portion of the handle is manipulable to move the basket and the chamber from the closed position toward the open position. When the chamber is in the open position, the handle is manipulable to remove the basket from the chamber.

In some embodiments, a beverage machine includes a housing, a liquid supply, a chamber, and a coupling. The liquid supply is configured to provide a liquid for forming a beverage, and may include a reservoir that is external to the housing. The chamber is configured to receive a beverage ingredient and includes an inlet configured to provide liquid from the liquid supply into the chamber. The coupling is configured to removably couple the reservoir to the housing at at least two discrete positions that are each fixed relative to the housing.

In some embodiments, a beverage machine includes a liquid supply, a liquid supply lid, a chamber, a housing, and a coupling. The liquid supply is configured to provide a liquid for forming a beverage, and may include a reservoir external to the housing. The liquid supply lid is removably coupleable to the reservoir. The chamber is configured to receive a beverage ingredient and includes a liquid inlet to provide liquid from the liquid supply for combining with the beverage ingredient to form a beverage. The housing supports at least a portion of the chamber. The coupling is configured to removably couple the liquid supply lid to the housing. At least a portion of the coupling is on the liquid supply lid.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1A is a perspective view of a beverage machine in an illustrative embodiment;

FIG. 1B is a top view of the beverage machine of FIG. 1A;

FIG. 1C is a front view of the beverage machine of FIG. 1A;

FIG. 1D is a side view of the beverage machine of FIG. 1A;

FIG. 2A is a schematic cross sectional side view of the beverage machine of FIG. 1A, showing a representative flow path;

FIG. 2B is a cross sectional view of the beverage machine of the beverage machine of FIG. 1A,

FIG. 3 is a schematic diagram of components of a beverage machine in an illustrative embodiment;

FIG. 4A is a perspective view of a brew chamber of a beverage machine in a closed position;

FIG. 4B is a perspective view of the brew chamber of FIG. 4A in an open position;

FIG. 4C is a perspective view of the brew chamber of FIG. 4A in an open position with a user removing a brew basket;

FIG. 5A is a schematic top plan view of a liquid supply of a beverage machine in a first position;

FIG. 5B is a schematic top plan view of the liquid supply of the beverage machine of FIG. 5A in a second position;

FIG. 5C is a schematic top plan view of the liquid supply of the beverage machine of FIG. 5A in a third position;

FIG. 6A is a perspective view of an upper portion of a liquid supply of a beverage machine;

FIG. 6B is a rear top right perspective view of an upper portion of a housing of a beverage machine; and

FIG. 6C is a rear top left perspective view of the upper portion of the housing of the beverage machine of FIG. 6B.

### DETAILED DESCRIPTION

It should be understood that aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

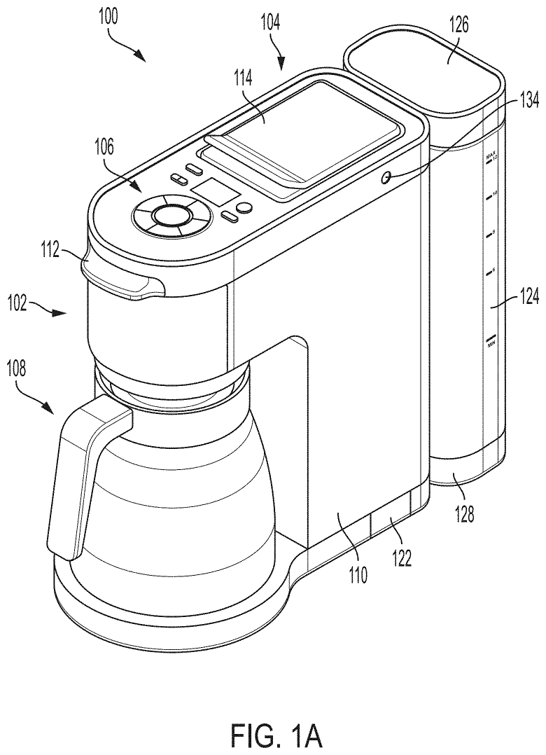

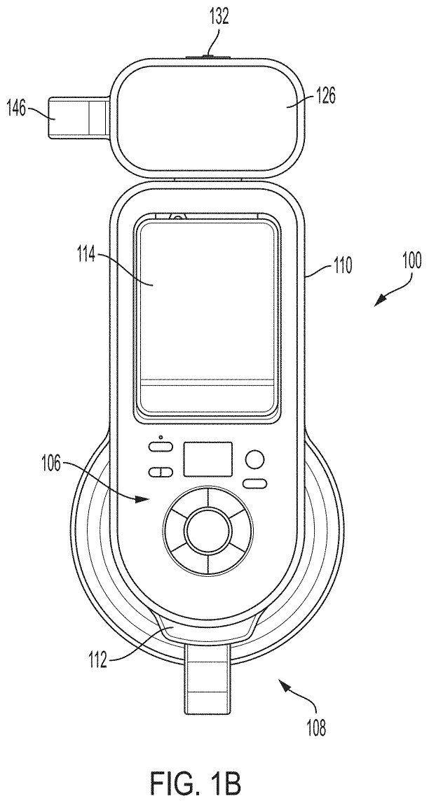

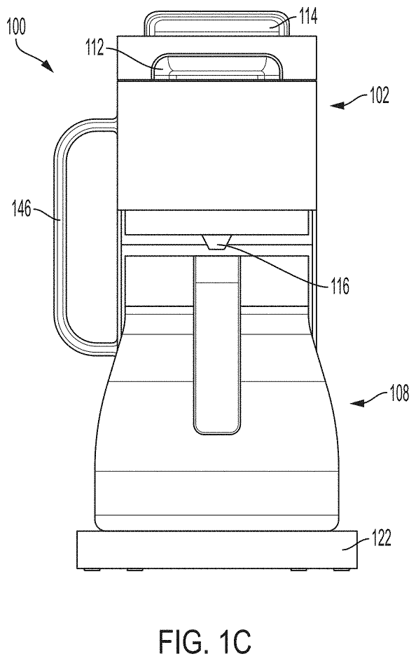

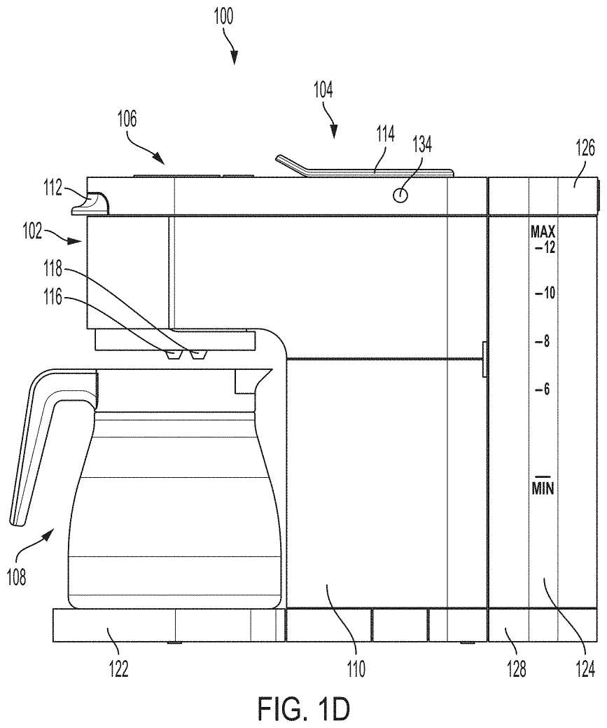

FIGS. 1A-1D show various views of a beverage machine 100 in an illustrative embodiment that incorporates aspects of the invention. The beverage machine may be used to form any suitable beverage, such as tea, coffee, other infusion-type beverages, beverages formed from a liquid or powdered concentrate, soups, juices, sodas, or other beverages made from dried materials. A beverage machine 100 may include one or more brew chambers. Each brew chamber may be configured to hold a beverage material, which, upon mixing with liquid from a liquid supply 124, may form a beverage.

It may be desirable to have a single machine that is configured to brew both single-serve beverage volumes and larger beverage volumes for multiple servings of a beverage, or otherwise have two separate brew chambers for making beverages, e.g., to avoid cross contamination. A beverage machine 100 may include a first brew chamber 102 and a second brew chamber 104. The first brew chamber 102 may be a configured to form a larger beverage volume compared to the second brew chamber 104, although this is not required. For example, the first brew chamber may be configured to brew multiple servings of a beverage and may dispense the beverage into a carafe 108, as shown in FIGS. 1A-1D. As explained above, other beverages in addition to coffee may be formed, as the disclosure is not so limited. The second brew chamber 104 may be configured to form a smaller beverage volume compared to the first brew chamber 102. For example, the second brew chamber may be configured to brew a single-serve beverage volume, although again, this is not required. The second brew chamber 104 may include a cartridge holder configured to receive a cartridge that contains a beverage material. The second brew chamber may have a lid 114 that may be movable relative to a housing 110. Moving the lid may expose the second brew chamber and allow a user to place a cartridge into the cartridge holder.

Of course, brew chambers configured to form different beverage volumes may be arranged in other combinations. For example, the first brew chamber may be configured to form a smaller beverage volume than the second brew chamber, and the second brew chamber may be configured to form a larger beverage volume than the first brew chamber. In some embodiments, the first and second brew chambers may be configured to form beverages of the same volume. In some embodiments, the first and second brew chambers may each be configured to form a range of beverage volumes, where the ranges may overlap with one another. As such, the disclosure is not limited with regards to the beverage volume formed in each chamber.

Some aspects of the invention need not be implemented with an apparatus having two brew chambers configured to form different beverage volumes. For example, some aspects of the invention may be used with an apparatus having only a cartridge-receiving brew chamber for single-serve beverages. Some aspects of the invention may be used with an apparatus having only a brew chamber configured for producing large beverage volumes containing multiple servings. Some aspects of the invention may be employed with any suitably arranged apparatus, including drip-type coffee brewers, carbonated beverage machines, and others arranged to form a beverage regardless of how the beverage is formed. For example, a cartridge may include any suitable materials to form a beverage, such as a carbon dioxide source used to carbonate water, a beverage mix, etc. Alternately, beverage ingredients need not be contained in a cartridge, but rather may be provided to the brew chamber in a loose or uncontained form. In such embodiments, the brew chamber may include a disposable or reusable filter to hold the beverage ingredient so that water or other liquid can be introduced to the brew chamber via an inlet and combined with the beverage ingredient to form a beverage that flows through the filter to an outlet of the brew chamber.

As stated above, it may be desirable to have a single beverage machine with two brew chambers, and some aspects herein relate to the relative positioning of these brew chambers. According to one aspect, the first brew chamber 102 is positioned in front of the second brew chamber 104. There may be certain advantages associated with positioning one brew chamber in front of another. For example, the first brew chamber 102 may be configured to produce larger beverage volumes and/or to use loose coffee grounds or other beverage material in front of the second brew chamber 104 which may be configured to produce smaller beverage volumes and/or to use containerized beverage materials. As the first brew chamber may be a batch-style brew chamber that may receive, for example, a filter and loose, ground coffee that may be inserted by a user, positioning the first brew chamber towards the front of the beverage machine 100 may provide ease of access to the first brew chamber by the user.

According to one aspect, the first and second brew chambers are aligned with one another, where the first brew chamber is positioned in front of the second brew chamber. An in-line configuration of the brew chambers may result in a more streamlined and overall smaller footprint for the machine, which may help the machine fit into smaller spaces.

Relative to a base 122 of a beverage machine 100, a first brew chamber 102 may be disposed at a height equal to a height of a second brew chamber 104. In some embodiments the first brew chamber may be disposed at an elevation below the second brew chamber, while in other embodiments the first brew chamber may be disposed at an elevation above the second brew chamber.

In some embodiments, a user interface 106 may be provided with a beverage machine 100. The user interface may be oriented so as to be viewed by a user positioned at the front of the beverage machine. A user interface 106 may include one or more of the following: a display, one or more buttons, and one or more indicator lights. The user may provide commands to the beverage machine through the user interface by, for example, pressing a button or touching a touch screen. The beverage machine may perform different functions in response to the commands from the user. For example, a beverage may be formed in a first brew chamber 102 in response to a user inputting a first type of command via the user interface, while a beverage may be formed in a second brew chamber 104 in response to a user inputting a second type of command via the user interface. Information may be communicated to the user through a display or indicator lights of the user interface.

It should be understood that a user interface may include any number or combination of the above-mentioned components, or any other appropriate components. In some embodiments, a user interface may include only a single touch screen that both receives commands from a user and communicates information to the user. In other embodiments, a user interface may include multiple buttons and multiple indicator lights. A user interface may include knobs, scroll wheels, mechanical switches, microphones, touch sensors, light sensors, or any other suitable components configured to receive input from a user. Additionally, a user interface may include displays, lights, speakers, haptic devices, or any other suitable components configured to provide information to a user.

According to one aspect, a user interface may be disposed above a first brew chamber 102. In some embodiments, the user interface may be disposed on a portion of the housing that is located directly above the first brew chamber. In some embodiments, positioning the user interface directly above the first brew chamber may help to provide ease of access to a user. In some embodiments, in addition to being disposed above the first brew chamber 102, the user interface may also be disposed in front of a second brew chamber 104. In embodiments in which the second brew chamber includes a lid 114, the user interface may be disposed in front of the lid of the second brew chamber. As stated above, an in-line configuration of the first and second brew chambers may provide certain benefits, such as a compact footprint. In some embodiments, the user interface 106 may be in-line with both the first brew chamber 102 and the second brew chamber 104. That is, when a beverage machine 100 is viewed from above, as in FIG. 1B, a single line may pass through the user interface and the first and second brew chambers. Stated differently, a single vertical plane may pass through the user interface and the first and second brew chambers. In some embodiments, the user interface 106 may be positioned at a height that may be equal to a height of the second brew chamber 104, where height is vertical distance from a base 122 of the beverage machine. In embodiments in which the second brew chamber includes a lid 114, the user interface may be positioned at a height that may be equal to a height of the lid of the second brew chamber.

According to one aspect, a beverage machine has more than one brew chamber, and a beverage formed from each of the brew chambers is dispensed from the beverage machine at a single dispensing region of the machine.

In a beverage machine with multiple brew chambers, there may be advantages associated with dispensing beverages formed in any brew chamber from a single dispensing region. With a single beverage dispensing region, a beverage machine with multiple brew chambers may have a smaller form factor compared to a beverage machine with multiple beverage dispensing regions. Additionally, having a single dispensing region may help prevent a user from accidentally placing a beverage container, such as a cup, at an incorrect beverage dispensing region, as there is only one such region. For example, in a beverage machine with multiple beverage dispensing regions, a user may place a cup at a first beverage dispensing region associated with a first brew chamber, but may form a beverage in a second brew chamber associated with a second beverage dispensing region. In such a situation, the beverage formed in the second brew chamber may dispense freely at the second beverage dispensing region rather than dispensing into the user's cup at the first beverage dispensing region, resulting in a spill that may then require cleaning. Such undesirable situations may be avoided in a beverage machine with a single beverage dispensing region.

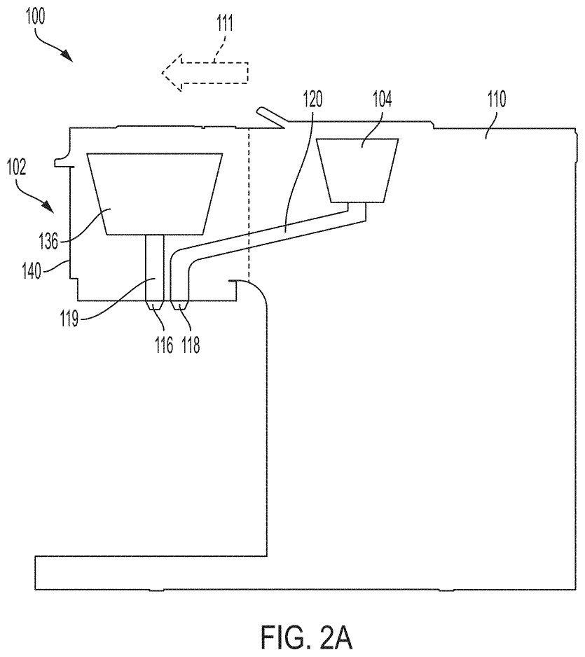

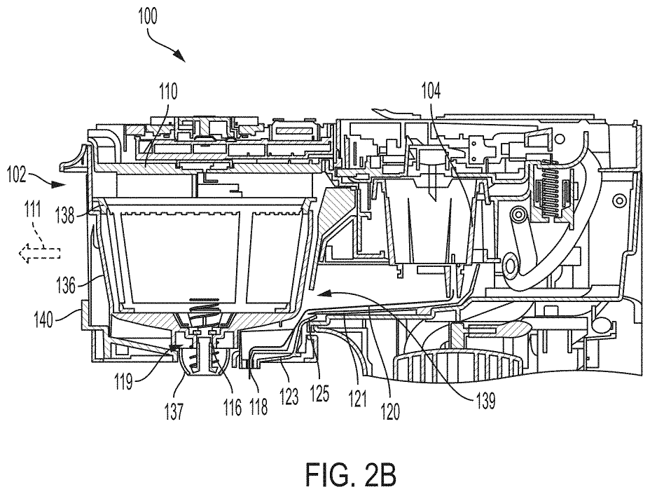

Referring now to FIG. 2A, a beverage machine 100 may include a first outlet 116 configured to dispense a beverage formed in a first brew chamber 102, and a second outlet 118 configured to dispense a beverage formed in a second brew chamber 104. The first outlet may be fluidly connected to a brew basket 136 of the first brew chamber through a first flow path 119, so that the beverage formed in the first brew chamber 102 may dispense through the first outlet 116 after travelling through the first flow path. The beverage formed in the second brew chamber 104 may be routed through a second flow path 120 so as to dispense through the second outlet 118 after travelling through the second flow path 120. In some embodiments, the second outlet 118 may be associated with the first brew chamber 102. In such embodiments, the second flow path 120 may route the beverage formed in the second brew chamber 104 into the first brew chamber 102 before dispensing through the second outlet 118.

In some embodiments, a first brew chamber 102 may include a brew basket 136 and a brew basket holder 140, where the brew basket is received within the brew basket holder. In such embodiments, a beverage formed in a second brew chamber 104 may be routed into the brew basket holder 140 of the first brew chamber 102. In some embodiments, a beverage formed in the second brew chamber 104 may not be routed into the brew basket 136. In other embodiments, however, a beverage formed in the second brew chamber 104 may be routed into the brew basket 136. For example, a beverage formed in the second brew chamber 104 may be routed into the brew basket 136 of the first brew chamber 102 to mix with an additional beverage ingredient, such as a flavoring.

In some embodiments, a second flow path 120 includes one or more channels. The one or more channels may include open channels, such as troughs, or closed channels, such as tubes. In some embodiments, the first and second flow paths may be distinct such that there is no fluid communication between the first and second flow paths. In some embodiments, mixing of a beverage formed in a first brew chamber 102 and a beverage formed in a second brew chamber 104 may be prevented. In other embodiments, a beverage formed in a first brew chamber 102 may be permitted to mix with a beverage formed in a second brew chamber 104. In some embodiments, fluid communication may occur between the first and second flow paths. It should be appreciated that mixing of beverages due to a configuration of the first and second flow paths may be independent of whether the second flow path is routed into the brew basket 136 or the brew basket holder 140. That is, the first and second flow paths may be configured to promote mixing of beverages at locations outside the first brew chamber 102. In some embodiments, beverages may be mixed at a point downstream from the first brew chamber, e.g. in a mixing chamber, or mixed mid-stream as the beverages are dispensed out of the beverage machine.

A second outlet 118 of a beverage machine 100 may be disposed adjacent to a first outlet 116. In some embodiments, such as the embodiment shown in FIG. 2A, the second outlet may be disposed behind the first outlet. In other embodiments, the second outlet may be disposed to a side of the first outlet. Generally, the relative positions of the first and second outlets may be in any suitable configuration such that beverages formed in either the first brew chamber 102 or second brew chamber 104 dispense at a single region, as the disclosure is not limited in this regard.

FIG. 2B provides an illustrative embodiment of a cross-section of a beverage machine 100. The beverage machine 100 includes a first brew chamber 102 and a second brew chamber 104, where the first brew chamber 102 has a larger volume than that of the second brew chamber 104. The first brew chamber 102 includes a brew basket holder 140, and a brew basket 136. A filter 138 is held within the brew basket 136.

A first flow path 119 routes beverage from the first brew chamber 102 to a first outlet 116. In the illustrative embodiment of FIG. 2B, the brew basket 136 includes a valve 137 at the first outlet 116 of the first flow path 119.

A second flow path 120 routes beverage from the second brew chamber 104 to a second outlet 118. In the illustrative embodiment of FIG. 2B, the second flow path 120 includes a first trough 121 and a second trough 123 downstream from the first trough 121. The first trough 121 guides beverage toward an opening 139 into the brew basket holder 140 of the first brew chamber 102. The second trough 123 then guides beverage flowing through the opening 139 toward the second outlet 118. The second trough 123 may include a ledge 125. The ledge 125 may extend through the opening 139 of the brew basket holder 140 to aid in guiding beverage into the second trough 123 and toward the second outlet 118. In other embodiments, a portion of the first trough 121 may extend through an opening of the brew basket holder. Either or both troughs 121, 123 may be removable from the beverage machine 100 for cleaning and/or maintenance.

A beverage machine may include a fluid system upstream of any brew chambers. The upstream fluid system may include, for example, a liquid supply, a liquid heater, pumps, and valves, to name a few components. A beverage machine 100 with a first brew chamber 102 and a second brew chamber 104 may include a user interface 106 that allows a user to choose between forming a beverage in the first brew chamber and forming a beverage in the second brew chamber. There may be advantages associated with a beverage machine with multiple brew chambers but only a single upstream fluid system. For example, such a beverage machine may be smaller and less complex than a beverage machine with separate upstream fluid systems associated with each brew chamber. In a beverage machine with only a single upstream fluid system, choosing between forming a beverage in the first brew chamber and the second brew chamber may include fluidly connecting the first brew chamber or the second brew chamber to the upstream fluid system. Consequently, such a beverage machine may require a valve, such as a three-way valve, for selecting between brew chambers. The configuration of the valve may be used to determine which volume selection options are provided by the user interface.

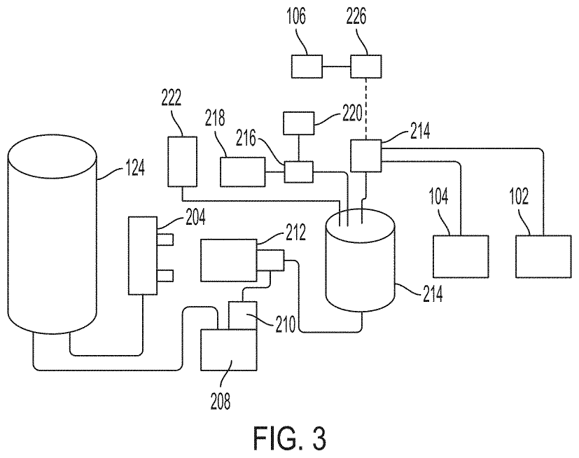

FIG. 3 is a schematic diagram of a fluid system of a beverage machine in an illustrative embodiment. The fluid system may include a liquid supply 124, such as a cold water tank. In general, the liquid supply may include a reservoir configured to hold liquid. The water level of the cold water tank may be monitored by a sensor 204. If the sensor 204 detects that there is insufficient water in the cold water tank, the sensor may send a signal to a user interface 106 to alert a user. Water from the cold water tank may pass through a filter 208 and a check valve 210 before being pumped by a pump 212 into a hot water tank 214. The water may be heated within the hot water tank 214 (e.g., via a heating element inside the hot water tank 214), and/or may be heated while traveling along the pathway to the hot water tank 214 (e.g., via an in-line heater). An air pump 222 may be connected to the hot water tank 214 to introduce air into the hot water tank for delivery of hot water to the brew chambers. The beverage machine may include a pressure release valve 216 that may be connected to a pressure transducer 218 that monitors pressure levels. In the case that the pressure transducer determines that pressure levels are too high, the pressure release valve may reduce the pressure levels through a vent 220. In some embodiments, the vent is passive, and not controllable. In embodiments in which the vent is controllable, the vent may be directly connected to the hot water tank. A valve 224 may selectively fluidly connect the hot water tank 214 to a first brew chamber 102 and a second brew chamber 104. In some embodiments, the valve 224 may be actuated by a controller 226, which may receive commands from the user interface 106.

According to one aspect, the user-selectable options that are provided by a user interface are determined based on the state of a valve that controls flow of liquid to either a first brew chamber or a second brew chamber. For example, the valve may have a first configuration in which a first brew chamber 102 is fluidly connected to a hot water tank 214 and a second configuration in which a second brew chamber 104 is fluidly connected to the hot water tank 214. When the valve is in the first configuration, the user interface provides a first set of options. When the valve is in the second configuration, the user interface provides a second set of options. In some embodiments, the user-selectable options that vary based on the state of the valve are volume selection options. Alternatively or in addition, other possible user-selectable options that may vary based on the state of the valve include, but are not limited to: beverage type options, temperature selection options, brew strength options, flavoring options, options relating to addition of ingredients such as sugar, cream or whipped cream, and/or options relating to amount of carbonation.

It should be understood that, in some embodiments, the first and second sets of options may contain some options that are the same. For example, with volume selection options, the first set of volume selection options may include options for brewing a beverage that may be 16 ounces, 32 ounces, or 64 ounces. The second set of volume selection options may include options for brewing a beverage that may be 4 ounces, 6 ounces, 8 ounces, 12 ounces, or 16 ounces. Although the option of brewing a 16 ounce beverage may be selected in either set in this example, the first set of volume selection options still differs from the second set of volume selection options.

In some embodiments, the valve 224 is actuated by a controller 226, as stated above. In some embodiments, the valve is operated manually by a user. For example, a user may interact with a physical interface, such as pushing a button, pulling a lever, or moving a slider, where the physical interface is mechanically coupled to the valve to change the configuration of the valve. As an illustrative example, pulling a lever to a first position actuates the valve to open fluid communication to the first brew chamber and to close fluid communication to the second brew chamber. Pulling the lever to a second position actuates the valve to open fluid communication to the second brew chamber and to close fluid communication to the first brew chamber.

In embodiments where the valve is operated manually by a user, a controller may still be included to perform other operations beyond actuating the valve. The state of the valve may be sent to the controller to determine the user-selectable options provided by the user interface. A sensor may be used to determine the state of the valve. In embodiments that include an actuator, the state of the actuator may be used to determine the state of the valve.

The valve 224 may include a three-way valve, or multiple two-way valves working in concert. In embodiments with additional connections, other valve configurations, such as four-way valves, may be used. It should be appreciated that any suitable valve or combination of valves that selectively connects at least one input to at least two outputs may be used, as the disclosure is not limited in this regard. Examples of possible valves include, but are not limited to, solenoid valves, ball valves, butterfly valves, pinch valves, or any other suitable type of valve.

As discussed above, in some embodiments, the beverage machine includes a batch-style brew chamber configured to produce beverage volumes with multiple servings. According to one aspect, a portion of the batch-style brew chamber includes a handle that allow a user to both open the brew chamber and remove beverage ingredients from the brew chamber.

With regard to this aspect, it should be appreciated that some embodiments of the beverage machine have only a single brew chamber. However, in other embodiments, the beverage machine may have more than one brew chamber. It should be appreciated that embodiments that include more than one brew chamber may include more than one handle, as the disclosure is not limited to a single handle. Additionally, it should be appreciated that a handle may be associated with any type of brew chamber, as the disclosure is not limited to handles associated with batch-style brew chambers.

As discussed above, a user interface 106 may be disposed directly above a first brew chamber 102 to allow easy access for a user standing at a front of a beverage machine 100. Due to the positioning of the user interface, it may be desirable to be able to access the inside of the first brew chamber in a manner that does not require opening of a lid that is above the first brew chamber. In some embodiments, a user may access the inside of the first brew chamber by moving the first brew chamber relative to the housing 110, as discussed below.

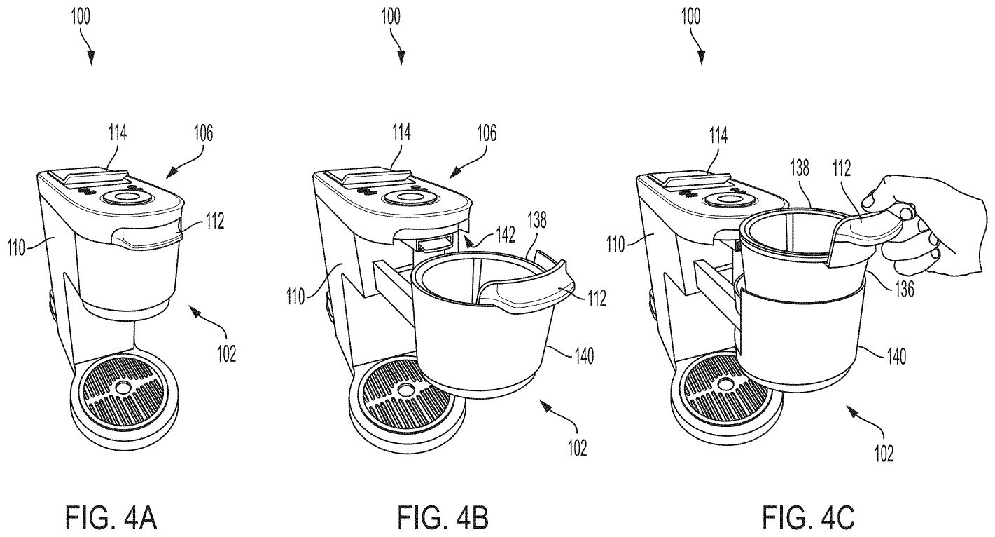

Referring now to the illustrative embodiments shown in FIGS. 4A-4C, the first brew chamber 102 of a beverage machine 100 includes a handle 112 that may be manipulated to open the first brew chamber, allowing a user to place a beverage material in the first brew chamber. In some embodiments, the first brew chamber 102 includes a brew basket 136 and a brew basket holder 140, where the brew basket is received within the brew basket holder. The brew basket holder may be movable relative to the housing, and the brew basket may move with the brew basket holder. In FIG. 2A, the movement of the first brew chamber 102 (including the brew basket 136 and the brew basket holder 140) is illustrated schematically, where the dotted line represents the interface between the moveable first brew chamber 102 and the stationary housing 110. The dotted arrow 111 represents the movement direction of the first brew chamber 102 relative to the housing 110.

In some embodiments, the first brew chamber 102 may further include a filter 138 that is held within the brew basket 136. The filter may be removable from the brew basket, or may be fixed to the brew basket. The brew basket 136 may be configured to receive a beverage material for mixing with liquid from the liquid supply 124 to form a beverage. Liquid from the liquid supply may be delivered to the first brew chamber through an inlet. In some embodiments, the handle 112 may be coupled, and in some embodiments, fixed, to the brew basket 136 and/or to the filter 138.

In the illustrative embodiment shown in FIG. 2B, the first brew chamber 102, which includes the brew basket 136 and the brew basket holder 140, is moveable relative to the housing 110 of the beverage machine 100. The brew basket holder 140 may slide linearly out of a recess in the housing 110, similar to a sliding drawer, in the direction of dotted arrow 111. The second trough 123, which forms a portion of the second flow path 120 that routes beverage from the second brew chamber 104 to the second outlet 118, moves with the brew basket holder 140 as the brew basket holder 140 is moved relative to the housing 110. In the embodiment of FIG. 2B, the first trough 121 remains stationary with the housing 110 as the brew basket holder 140 and the second trough 123 are moved relative to the housing 110.

FIG. 4A shows the beverage machine 100 with the first brew chamber 102 in a closed position. In the closed position, the first brew chamber may engage with the housing 110 of the beverage machine, so that at least a portion of the first brew chamber (e.g., the brew basket holder 140 of the first brew chamber) forms part of an outer surface of the beverage machine. The handle 112 coupled to the brew basket 136 and/or the filter 138 may be exposed when the first brew chamber is in the closed position. In some embodiments, the handle 112 may extend through an opening 142 (shown in FIG. 4B) in the housing when the first brew chamber is in the closed position.

A user may manipulate the handle 112 to move a first brew chamber 102 from a closed position into an open position. For example, in some embodiments, the user may grasp the handle and pull back, causing the first brew chamber 102 to translate away from the housing 110 of the beverage machine 100. In other embodiments, manipulating a handle may cause a first brew chamber to rotate relative to a housing. In yet other embodiments, manipulating a handle may cause a first brew chamber to undergo a combination of translation and rotation relative to a housing. Regardless of whether the first brew chamber may translate and/or rotate, manipulating the handle may cause at least a portion of the first brew chamber to move relative to the housing. In embodiments in which the first brew chamber 102 includes a brew basket 136 and a brew basket holder 140, manipulating the handle 112 to move the first brew chamber includes moving the brew basket and the brew basket holder. In embodiments in which the first brew chamber 102 includes a filter 138, manipulating the handle 112 to move the first brew chamber also includes moving the filter.

FIG. 4B shows the beverage machine 100 with the first brew chamber 102 in an open position. In the open position, the first brew chamber may be exposed, allowing a user to place a beverage material into the brew basket 136 associated with the first brew chamber. In some embodiments, a filter 138 may be held within the brew basket 136 of the first brew chamber 102. As discussed above, the filter may be removable from the brew basket, or the filter may be fixed to the brew basket. In embodiments that include a filter, a user may place a beverage material directly into the filter.

FIG. 4C shows a beverage machine 100 with a first brew chamber 102 in an open position with a user interacting with the handle 112. While in the open position, a user may manipulate the handle to remove the brew basket 136 from the brew basket holder 140 of the first brew chamber 102. In some embodiments, the brew basket 136 may be removed from the brew basket holder 140 in a direction that is perpendicular to an axis along which the first brew chamber 102 (which may include the brew basket holder 140 and the brew basket 136) moves when the first brew chamber moves between an open position and a closed position. For example, the first brew chamber 102 (which may include the brew basket holder 140 and brew basket 136) may move along an axis in a horizontal plane, while the brew basket 136 may be removed from the brew basket holder 140 in a vertical direction. In embodiments in which the brew basket 136 holds a filter 138, the filter may be removed with the brew basket when a user removes the brew basket from the brew basket holder 140.

As a first brew chamber 102 of a beverage machine 100 moves between a closed position and an open position, other components of the beverage machine may move as well. As an example, in embodiments in which the first brew chamber includes a brew basket 136, a brew basket holder 140, and/or a filter 138, these components may move as the first brew chamber moves. In some embodiments, a beverage machine may include a second flow path 120, which may fluidly connect a second brew chamber 104 to a second outlet 118, as shown in FIG. 2A. In some embodiments, at least a portion of the second flow path may move with the first brew chamber as the first brew chamber moves between the open and closed positions. That is, a portion of the second flow path may move relative to the second brew chamber as the first brew chamber moves between the open and closed positions. In FIG. 2A, the portion of the second flow path 10 to the left of the dotted line moves with the first brew chamber 102 relative to the housing 110, while the portion of the second flow path 10 to the right of the dotted line remains stationary with the housing 110.

Of course, the first brew chamber 102 may move relative to other components of the beverage machine 100 as the first brew chamber moves between the closed position and the open position. As stated above, liquid from the liquid supply 124 may be delivered to the first brew chamber through an inlet. In some embodiments, the first brew chamber may move relative to the inlet as the first brew chamber moves between the open and closed positions.

As discussed previously, a beverage machine with multiple brew chambers arranged in an in-line configuration may have a more compact footprint compared to beverage machines with other configurations of brew chambers. In keeping with the motivation for a compact footprint, it may be desirable for a liquid supply 124 to be positioned behind a housing of a beverage machine 100, as shown in FIGS. 1A-1D. However, while certain users may prefer a beverage machine with many components in-line, other users may prefer different configurations. For example, some users may want to place a beverage machine in spaces of different sizes or different shapes. As such, it may be advantageous for a beverage machine to have a customizable footprint. This customizability may be realized in a beverage machine with a movable liquid supply. Furthermore, some users may prefer increased stability over a compact footprint, and may want a liquid supply to be positioned to a side of the housing rather than behind the housing so as to provide greater stability. According to one aspect, a beverage machine includes a reservoir that is movable to different discrete positions relative to the beverage machine housing.

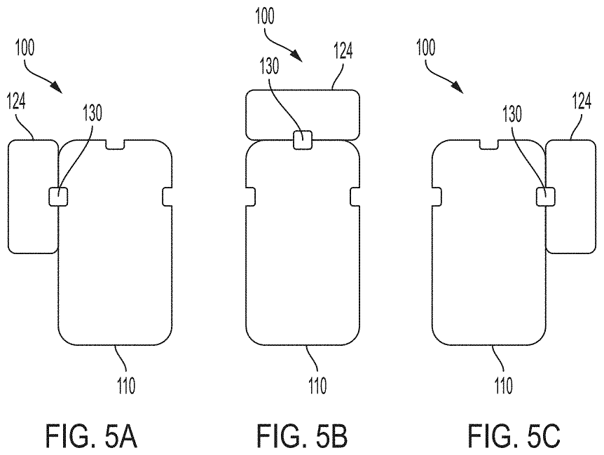

FIGS. 5A-5C depict schematics of a liquid supply 124 that is positioned in different discrete positions relative to a housing 110 of a beverage machine 100. It should be appreciated that each position of the liquid supply may be associated with a feature on the housing, as discussed below. That is, the liquid supply may only be able to be positioned at certain discrete positions relative to the housing. In each discrete position, the liquid supply may be secured in a distinctly defined orientation relative to the housing until disengaged by a user. Discrete positioning may enable greater stability of the beverage machine and may ensure that the liquid supply remains in a desired position. In some embodiments, once disengaged, the liquid supply may disconnect completely from the housing, until reengaged at another discrete position. However, in other embodiments, the liquid supply may be moved between positions without completely disconnecting the liquid supply from the housing, e.g., one or more fluid lines between the liquid supply and the housing may remain connected while allowing the liquid supply to be moved relative to the housing. The beverage machine may include detent and/or locking mechanisms that define the discrete positions of the liquid supply relative to the housing. That is, a liquid supply may be moved continuously relative to the housing, but a detent may define discrete positions within the continuous movement path, or a locking mechanism may serve to lock the liquid supply to a certain position, in which case the liquid supply is prevented from moving relative to the housing until the locking mechanism is disengaged.

FIG. 5A shows the liquid supply 124 on a first side of the housing 110 of the beverage machine 100. FIG. 5B shows the liquid supply behind the housing of the beverage machine. FIG. 5C shows the liquid supply on a second side of the housing of the beverage machine opposite the first side of the housing. While three different discrete positions are shown in FIGS. 5A-5C, it should be appreciated that more or fewer discrete positions are contemplated. In some embodiments, a liquid supply movable between at least two discrete positions relative to a housing, as the disclosure is not limited with regard to the number of discrete.

In some embodiments, a coupling 130 may be configured to removably couple the liquid supply 124 to the housing 110 of a beverage machine 100 at a plurality of different discrete positions. The coupling 130 may include any of a number of suitable components or mechanisms. As discussed above, a portion of the coupling may be included on a housing 110 of a beverage machine 100. In some embodiments, a coupling includes a latch and slot mechanism, in which a latch secures a body after the body is slid into a slot. To remove the body from the slot, a latch button is pressed to release the latch and allow the body to move. In another arrangement, the liquid supply may include a base on which a water tank is removably held. The base may include an engagement member arranged to engage with a corresponding receiving member of the housing in at least one discrete location. For example, the engagement member may include at least one spring tab constructed and arranged to engage with a corresponding catch on the housing, where engagement of the at least one spring tab with the corresponding catch removably secures the base relative to the housing. In another arrangement, the base includes a plug and the housing includes a plug receptacle arranged to receive the plug of the base so as to secure the base relative to the housing in at least two orthogonal directions, e.g., lateral and vertical directions. Thus, the plug of the base may be inserted laterally into the plug receptacle and held in place, e.g., by a spring latch. In other words, the plug may extend laterally from the base and the plug may be extended into the plug receptacle in a direction along which the plug extends. The housing may include two or more plug receptacles each arranged to receive and engage with the plug of the base, and so fix the liquid supply at a corresponding discrete location. The machine may have one or more dummy plugs separate from the base and arranged to be received by and engaged with a plug receptacle that is not engaged with the plug of the base. This may allow a user to cover or conceal a plug receptacle of the housing where the liquid supply is not located. In some embodiments, a coupling includes a pair of magnets, or a magnet paired with a ferromagnetic material. In some embodiments, a coupling includes a protruding element and a receiving cavity, where the protruding element is configured to be received in the receiving cavity. Other possible couplings include clips, threaded fasteners, ball detents, spring-loaded catches, or any other suitable components or mechanisms, as the disclosure is not so limited.

A liquid supply 124 may be coupled to a housing 110 of a beverage machine 100 either directly or indirectly. As an example of indirect coupling, in some embodiments, the liquid supply may have a tank that sits on a liquid supply base 128, which may be coupled to a base 122 of the beverage machine, as seen in FIG. 1A. In other embodiments, a liquid supply base 128 may couple to the housing 110 of the beverage machine.

As discussed above, a coupling 130 may couple a liquid supply 124 to a housing 110 at a bottom region of the liquid supply. In some embodiments, the beverage machine is flipped upside down for access to the coupling in order to reconfigure the position of the liquid supply. Alternatively, the coupling may be located at a middle region of the liquid supply, or at a top region of the liquid supply. As an example of the coupling being located at a top region of the liquid supply, a portion of the coupling may be located on a liquid supply lid 126. It should be appreciated that a coupling may be located in different positions on a liquid supply, and the disclosure is not limited in this regard.

According to one aspect, the beverage machine includes a coupling configured to removably couple a liquid supply lid to a housing of the beverage machine. Such a coupling may be the only coupling connecting the liquid supply to the beverage machine housing, or may be an additional coupling. In embodiments in which the liquid supply is movable relative to the housing and a coupling 130 is used to removably couple the liquid supply to the housing, it may be desirable to provide one or more additional methods of securing the liquid supply to the housing beyond the coupling 130.

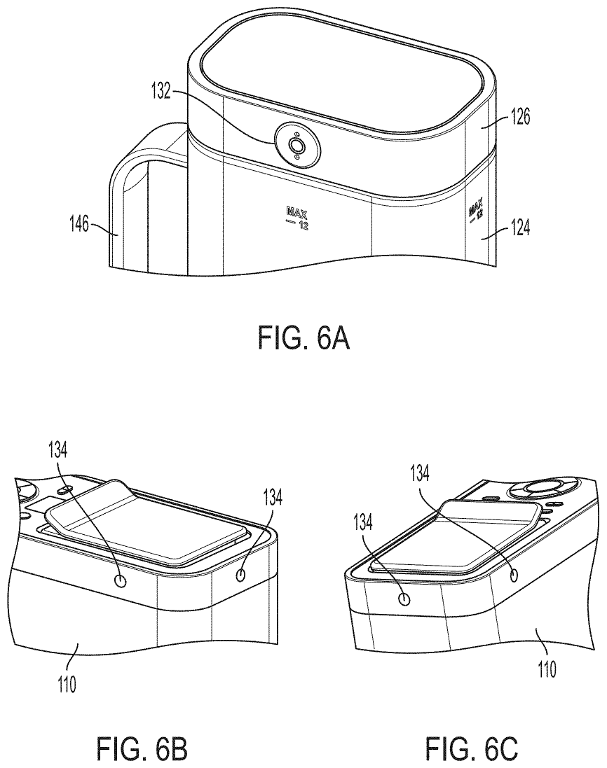

Turning now to FIGS. 6A-6C, the liquid supply 124 may include a liquid supply lid 126, which may include a portion of a liquid supply lid coupling. In some embodiments, the liquid supply lid coupling may include a first portion 132 disposed on the liquid supply lid 126, and a second portion 134 disposed on the housing 110 of the beverage machine 100. The first portion of the liquid supply lid coupling 132 may be configured to removably engage with the second portion of the liquid supply lid coupling 134 to removably couple the liquid supply lid to the housing. In some embodiments, instead of being disposed on the housing, the second portion of the liquid supply lid coupling 134 may be otherwise included in the beverage machine. In other embodiments, the beverage machine does not include a second portion of the liquid supply lid coupling 134. The first portion of the liquid supply lid coupling may include magnets, ferromagnetic materials, latches, threaded fasteners, protruding elements, receiving cavities, or any other suitable components, as the disclosure is not limited in this regard. In embodiments that include a second portion of the liquid supply lid coupling, the second portion of the liquid supply lid coupling may similarly include any one of the aforementioned couplings.

In embodiments in which a liquid supply 124 may be movable with respect to a housing 110 of a beverage machine 100, as shown in FIGS. 5A-5C, a liquid supply lid coupling may have the ability to accommodate different configurations of the liquid supply relative to the housing. For example, referring to FIG. 6A, a first portion of the liquid supply lid coupling 132 may include components in multiple locations on a liquid supply lid 126, although only one is shown in the figure for clarity. Similarly, a second portion of the liquid supply lid coupling 134 may include components in multiple locations on the housing, as shown in FIGS. 6B-6C. In addition to enabling different positions of the liquid supply relative to the housing, the multiple components of the first and second liquid supply lid coupling may enable different orientations of the liquid supply within a given position. For example, when the liquid supply is positioned behind the housing, the entire liquid supply may be reoriented so as to flip the position of a liquid supply handle 146 of the liquid supply while keeping the liquid supply behind the housing.

In addition to accommodating different positions of the liquid supply, disposing components of the liquid supply lid coupling in multiple locations may enable the liquid supply lid 126 to be placed on the liquid supply 124 in different orientations and still couple to the housing 110. For example, in some embodiments, a first portion of the liquid supply lid coupling 132 may include magnets disposed on both a first side of the liquid supply lid 126 and a second side of the liquid supply lid opposite the first side. Additionally, a second portion of the liquid supply lid coupling 134 may include ferromagnetic material disposed on the housing 110. In these embodiments, the liquid supply lid may be positioned in a first orientation in which the magnets on the first side of the liquid supply lid 126 couple to the ferromagnetic material on the housing 110. The liquid supply lid may be reoriented with respect to the liquid supply 124 (e.g., rotated 180 degrees about a vertical axis) so as to be positioned in a second orientation in which the magnets on the second side of the liquid supply lid 126 couple to the ferromagnetic material on the housing.

A liquid supply lid coupling may couple a liquid supply lid 126 to a housing 110 such that a liquid supply 124 and the liquid supply lid may be positioned adjacent to the housing. That is, the liquid supply lid coupling may retain the liquid supply in close proximity to the housing. Additionally, when the liquid supply lid coupling couples the liquid supply lid to the housing, the liquid supply lid may engage the liquid supply in a lateral direction, holding the liquid supply to the housing. In this way, the liquid supply lid coupling may provide added stability to a beverage machine. For example, a coupling 130 may couple a liquid supply base 128 to a base 122 of a beverage machine 100, as may be seen in FIG. 1A. While such a configuration may secure a bottom portion of the liquid supply to the housing, a top portion of the liquid supply may remain unsecured. Consequently, a liquid supply lid 126 may include a first portion of a liquid supply lid coupling that may secure the top portion of the liquid supply to the housing by engaging with a second portion of a liquid supply lid coupling that may be disposed on the housing.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A beverage machine comprising:
a housing;
a user interface oriented to be viewed by a user positioned at a front of the beverage machine;
a liquid supply configured to provide a liquid for forming a beverage, the liquid supply being coupled to the housing;
a first chamber configured to hold a first beverage material for mixing with liquid from the liquid supply to form a first beverage; and
a second chamber comprising a cartridge holder configured to receive a beverage cartridge having a second beverage material for mixing with liquid from the liquid supply to form a second beverage,
wherein the second chamber is distinct from the first chamber and is disposed behind the first chamber.

2-9. (canceled)

10. A beverage machine comprising:
a housing;
a liquid supply configured to provide a liquid for forming a beverage, the liquid supply being coupled to the housing;
a first chamber configured to hold a first beverage material for mixing with liquid from the liquid supply to form a first beverage;
a second chamber comprising a cartridge holder configured to receive a beverage cartridge having a second beverage material for mixing with liquid from the liquid supply to form a second beverage;
a base supporting the beverage machine, the base being at a bottom of the beverage machine; and
a user interface oriented to be viewed by a user positioned at a front of the beverage machine,
wherein the user interface is disposed above the first chamber.

11-15. (canceled)

16. A beverage machine comprising:
a housing;
a liquid supply configured to provide a liquid for forming a beverage, the liquid supply being coupled to the housing;
a first chamber configured to hold a first beverage material for mixing with liquid from the liquid supply to form a first beverage;
a second chamber comprising a cartridge holder configured to receive a beverage cartridge having a second beverage material for mixing with liquid from the liquid supply to form a second beverage; and
a flow path fluidly connecting the second chamber to the first chamber.

17. The beverage machine of claim 16, further comprising:
a first outlet configured to allow the first beverage to exit the first chamber; and
a second outlet configured to allow the second beverage to exit the first chamber.

18. The beverage machine of claim 17, wherein the second outlet is disposed adjacent to the first outlet.

19. The beverage machine of claim 18, further comprising a user interface oriented to be viewed by a user positioned at a front of the beverage machine, wherein the second outlet is disposed behind the first outlet.

20. The beverage machine of claim 18, further comprising a user interface oriented to be viewed by a user positioned at a front of the beverage machine, wherein the second outlet is disposed to a side of the first outlet.

21. The beverage machine of claim 18, further comprising a user interface oriented to be viewed by a user positioned at a front of the beverage machine, wherein the second outlet is disposed in front of the first outlet.

22. The beverage machine of claim 16, wherein the flow path includes a trough.

23. The beverage machine of claim 16, wherein the flow path includes a tube.

24. The beverage machine of claim 16, wherein at least a portion of the flow path is configured to move with the first chamber relative to the housing.

25. The beverage machine of claim 16, wherein at least a portion of the flow path is configured to move relative to the second chamber.

26. A beverage machine comprising:
a liquid supply configured to provide a liquid for forming a beverage;
a first chamber configured to hold a first beverage material for mixing with liquid from the liquid supply to form a first beverage;
a second chamber comprising a cartridge holder configured to receive a beverage cartridge having a second beverage material for mixing with liquid from the liquid supply to form a second beverage; and
a user interface configured to permit selection of one of a first mode for forming the first beverage in the first chamber and a second mode for forming the second beverage in the second chamber, the user interface being configured to provide volume selection options based on the selected mode,
wherein:
selection of the first mode causes the user interface to provide a first set of volume selection options, and
selection of the second mode causes the user interface to provide a second set of volume selection options, the second set of volume selection options being different from the first set of volume selection options.

27. The beverage machine of claim 26, wherein the user interface comprises a mechanical switch.

28. The beverage machine of claim 26, further comprising a valve having a first configuration corresponding to selection of the first mode and a second configuration corresponding to selecting of the second mode.

29. The beverage machine of claim 26, wherein the user interface comprises at least one button.

30. (canceled)

31. A beverage machine comprising:
a housing;
a liquid supply configured to provide a liquid for forming a beverage;
a basket configured to receive a beverage ingredient for mixing with liquid from the liquid supply to form a beverage;
a handle attached to the basket; and
a chamber configured to hold the basket, the chamber being configured to receive liquid from the liquid supply, and the chamber being movable relative to the housing between an open position and a closed position,
wherein:
at least a portion of the handle is positioned outside of the chamber when the chamber is in the closed position,
the at least a portion of the handle is manipulable to move the basket and the chamber from the closed position toward the open position, and
the handle is manipulable to remove the basket from the chamber when the chamber is in the open position.

32-39. (canceled)

40. A beverage machine comprising:
a housing;
a liquid supply configured to provide a liquid for forming a beverage, the liquid supply including a reservoir;
a chamber configured to receive a beverage ingredient, the chamber including an inlet configured to provide liquid from the liquid supply into the chamber; and
a coupling configured to removably couple the reservoir to the housing at at least two discrete positions that are each fixed relative to the housing.

41-50. (canceled)

51. A beverage machine comprising:
a liquid supply configured to provide a liquid for forming a beverage, the liquid supply including a reservoir;
a liquid supply lid that is removably coupleable to the reservoir;
a chamber configured to receive a beverage ingredient, the chamber including a liquid inlet to provide liquid from the liquid supply for combining with the beverage ingredient to form a beverage;
a housing supporting at least a portion of the chamber; and
a coupling configured to removably couple the liquid supply lid to the housing, at least a portion of the coupling being on the liquid supply lid.

52-60. (canceled)

61. A beverage machine comprising:
a liquid supply arranged to provide a liquid for forming a beverage, the liquid supply including a water reservoir;
a brew chamber arranged to hold a beverage material for mixing with the liquid to form a beverage;
a liquid conditioner arranged to heat or cool the liquid that is provided to the brew chamber; and
a housing arranged to support at least portions of the liquid supply, brew chamber and liquid conditioner,
wherein the housing and the water reservoir are constructed and arranged to mechanically connect the water reservoir to the housing at at least two discrete locations that are each fixed relative to the housing.

62-75. (canceled)
